(19) United States
(12) Patent Application Publication
(10) Pub. No.: US 2019/0254777 A1
(43) Pub. Date: Aug. 22, 2019

(54) TOOTH EXTRACTOR

(71) Applicant: SHANNON GUSE, CLYDE PARK, MT (US)

(72) Inventor: SHANNON GUSE, CLYDE PARK, MT (US)

(21) Appl. No.: 15/419,546

(22) PCT Filed: Nov. 14, 2016
(86) PCT No.: PCT/US2016/061915

§ 371 Date: Jan. 30, 2017

(51) Int. Cl. A61C 3/14; A61C 3/03; A61C 3/08

(52) U.S. Cl. CPC A61C 3/14; A61C 3/08; A61C 3/03

(57) ABSTRACT

The invention relates to a method of extracting a tooth from the jawbone of an animal with a tooth extraction device. The tooth extraction device includes an opening at the first end of a rod member that holds the tooth for extraction while applying a hammer like force thereto.

### CROSS REFERENCE TO RELATED APPLICATIONS

This application claims benefit of an earlier filing date to PCT/US16/61915, confirmation no. 4230, title: TOOTH EXTRACTOR, with same inventive entity of Shannon Guse, atty. Doc. no. 013-PCT, filed on 14, Nov. 2016.

### FEDERALLY SPONSORED RESEARCH AND DEVELOPMENT

Not applicable.

### MICROFICHE

Not applicable

### BACKGROUND OF THE INVENTION

### (1) Field of the Invention

This invention relates to the field of dentistry, and in particular to the extraction of teeth and/or roots of teeth from the jaw of the animal, like Elk.

### (2) Background of the Invention

Sometimes called tusks, whistlers, or buglers, the canine teeth of wapiti are most commonly known as ivories. Technically, ivory is the term for any animal tusk used as material for art or manufacturing. Elk ivories are indeed tusks, of the same material and chemical composition as those sported by walruses, wild boars, and elephants. For many people ivories represent a gorgeous memento from the hunt. Ivories show up in rings, necklaces, bolo ties, earrings, hatbands, pendants, watches, cufflinks, belt buckles, and tie tacks. Most everyone who appreciates elk also admire the teardrop shape and buttery warm color of ivories. Like snowflakes, ivories also have the attraction of being truly one-of-a-kind, even those from opposite sides of the same animal's mouth. Jewelers who work extensively with elk ivories create repertoires of stock designs, but they still custom-sculpt each piece, following the contours of the individual tusk. For elk hunters, there may be no more beautiful or meaningful gem, no finer way to commemorate an exceptional hunt. The ivories must be harvested from an animal before they can be saved as mementos. A suitable extraction solution is desired.

Several attempts have been made to solve the above-mentioned problems such as those found in U.S. Patents Publications, which are herein incorporated by reference for their supportive teachings for enablement and other legal purposes, however, none of these patents, taken either singly or in combination, is seen to describe the invention as claimed; wherein the patent are as follows: U.S. Pat. No. 8,517,730 to Darwish, et. al.; U.S. Pat. No. 7,021,932 to Standish; 2013/0045459 to Vale; 2012/0115104 to Li; and 2009/0098509 to Weathers, additionally:

US20050214719 A1, discloses a method of extracting a tooth from the jawbone of a human being or an animal with a tooth extraction instrument, the tooth extraction instrument being able to be brought from an applying position in which the tooth extraction instrument may be applied to the tooth to be extracted into an extracting position in which the tooth extraction instrument is secured to the tooth to be extracted, comprising the steps: a) applying and grasping the tooth extraction instrument assuming the approaching position to the tooth to be extracted, b) fixing the tooth extraction instrument on the tooth to be extracted by transferring the tooth extraction instrument from the applying position to the extracting position, and c) performing extracting movements with the tooth extraction instrument for gently levering out the tooth to be extracted.

U.S. Pat. No. 5,306,141 to Stephen A. Sears discloses a tooth extractor which is designed to remove an equine cheek tooth from within the animal's mouth. The provided tooth extracting instrument in which uniquely designed molar forceps may grasp a tooth and by the action of two sets of articulating screw drives, or some other appropriate gear configuration, remove the tooth and root completely from its socket. The housing in which the two drive mechanisms are contained functions as a counter-bearing surface with adjacent molar or premolar teeth or other aspects of the mouth where it may find purchase.

U.S. Pat. No. 7,938,645 to Schubert L. Sapian discloses dental system for extracting a tooth portion from a socket in the jawbone of a human or an animal patient. The dental instruments disclosed herein include an extraction bur that can be coupled to a latch head from a slow speed latch dental hand piece so as to be rotated and embedded within the root or root tip to be extracted from the mouth of the patient. A set of barb-like screw threads enable the extraction bur to be affixed to the root or root tip.

A method of extracting a tooth out of a jawbone of an animal is, therefore, required which in a simple and safe way of extraction of teeth from animals. It would also be desirable for the operator to have easy extraction not to have to apply any additional forces during the extracting of the tooth in order to hold the tooth extraction instrument on the tooth to be extracted.

### SUMMARY OF THE INVENTION

In the view of the foregoing disadvantages inherent in the known types of tooth extraction device for removing a desired tooth from animals now present in the prior art, the present invention provides an improved tooth extraction device. As such, the general purpose of the present invention, which will be described subsequently in greater detail, is to provide a new and improved tooth extraction device, which has all the advantages of the prior art and none of the disadvantages.

In one embodiment there is a method of extracting a tooth from an animal, comprising providing a tooth extractor having: a rod member; a tooth chamber, having an opening located at one end of the rod; a handle located at an opposite end of the rod from the tooth chamber; placing the tooth chamber over a tooth to be extracted so that the tooth is located in the tooth chamber; striking the tooth extractor with sufficient force to extract the tooth from the jawbone of the animal; and removing the tooth extractor with the tooth located in the tooth chamber therein.

Wherein, in another embodiment, the method has the tooth chamber has an opening that is circular shape.

Moreover, in another embodiment the method has the tooth chamber with an opening that has two protrusions extending down from the edge of the tooth chamber opening, a first protrusion to be placed on an outside of a tooth, and a second protrusion to be located opposite the first protrusion and to fit over an opposite side of a tooth. Wherein the method of the first and second protrusion are placed over the tooth before striking the tooth extractor.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

These together with other objects of the invention, along with the various features of novelty which characterize the invention, are pointed out with particularity in the disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a perspective view of a tooth extraction device according to a first embodiment of the present invention.

FIG. 2 a side sectional view of an alternative embodiment of a tooth extractor.

FIG. 3 is a side view of the alternative embodiment in use thereof.

### DETAILED DESCRIPTION OF THE INVENTION

In the following detailed description, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that the embodiments may be combined, or that other embodiments may be utilized and that structural and logical changes may be made without departing from the spirit and scope of the present invention. The following detailed description is, therefore, not to be taken in a limiting sense, and the scope of the present invention is defined by the appended claims and their equivalents.

The tooth extractor is a device that is associated with the extraction of the teeth from an animal or human during dental and orthodontic procedures. Major anatomical differences, most veterinary extractions are actually often more difficult than extraction of a human's tooth.

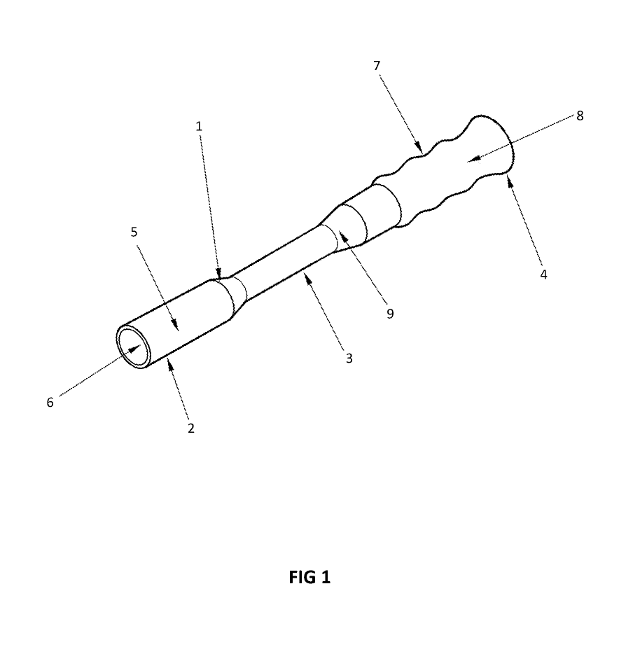

As shown in FIG. 1, a preferred embodiment of the invention is disclosed which illustrates a tooth extraction device, characterized by a rod member 1, a first end 2, a middle 3, a second end 4, a hollow chamber 5 at the first end, an opening 6 also referred to as a tooth cavity, a handle 7 with a proximal end 8 and a distal end 9.

Referring now to the drawing, in FIG. 1, there is shown a tooth extractor device in which the rod member 1 is made of a solid piece of material. The handle 7 is positioned at the distal end 9 of the second end 4.

The length of the rod member is 10″ inches, which includes 3½ inch handle, 2½ inch middle end and 4 inches first end. The diameter of the opening at the first end of the rod member is 2″ inches. Hardwood and plastic material is used for the manufacture the device.

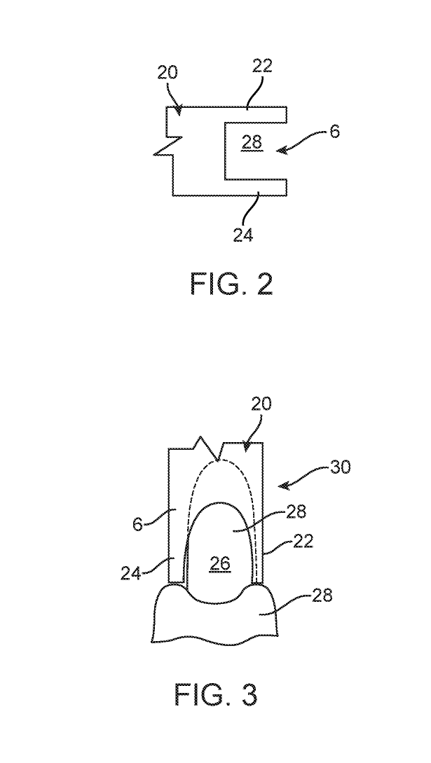

Referring now to FIG. 2, there is illustrated an alternative embodiment of a tooth extractor 20, with a modified tooth chamber opening 6. Specifically, there is shown two protrusions 22, 24 that are shaped to fit over the selected tooth, and the matching gaps 28 located between the two protrusions 22, 24 fit over or around the other teeth located around the desired tooth.

Referring now to FIG. 3, there is illustrated one embodiment of the tooth extractor 20 in use thereof of the device illustrated in FIG. 2. Specifically, there is the tooth extractor 20 positioned over a tooth 26 to be extracted. The first protrusion 22 is located on an outside surface of the tooth 26, and the mirror image second protrusion 24 is located on an inside of the mouth surface of the tooth 26. The gap 28 is located between the two protrusion 22, 24. Whereby, a hammer like force 30 is applied to the outside facing portion of the extractor 20 sufficient to dislodge the tooth 26 from the jawbone 28.

Focusing on the functioning of the tooth extractor there is as follows: the opening 6 at the first end 2 of the rod member 1, will be positioned over and around the desired tooth to be extracted. A user holds into the handle 7 at the opposite end of the rod member 1. A user then applies a hammer like force 30 to the tooth extractor 20 near where the tooth chamber 6 is located, and knocks the tooth out of the jawbone 28. Whereby, the loose tooth 26 is contained in the tooth cavity 6, and the user can now safely remove the tooth 26 from the animal's mouth.

It is noted that the present disclosure teaches the use of at hammer like device. Wherein, one skilled in the art of teeth extraction from a game animal, a hammer like device may be most any device, like an actual hammer, a boot, a rock, or a but of a rifle.

Also, although it is taught that the gaps 28 are illustrated in a square or rounded shape, where it is easily contemplated to have most any shape of gap that will suffice to fit over or around the other teeth of the animal.

It is to be understood that the above description is intended to be illustrative, and not restrictive. For example, the above-discussed embodiments may be used in combination with each other. Many other embodiments will be apparent to those of skill in the art upon reviewing the above description.

The benefits and advantages that may be provided by the present invention have been described above with regard to specific embodiments. These benefits and advantages, and any elements or limitations that may cause them to occur or to become more pronounced are not to be construed as critical, required, or essential features of any or all of the embodiments.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention.

What is claimed is:

1. A method of extracting a tooth from an animal, comprising:
a) providing a tooth extractor having:
i. a rod member;
ii. a tooth chamber, having an opening located at one end of the rod;
iii. a handle located at an opposite end of the rod from the tooth chamber;
b) placing the tooth chamber over a tooth to be extracted so that the tooth is located in the tooth chamber;
c) striking the tooth extractor with sufficient force to extract the tooth from the jawbone of the animal; and
d) removing the tooth extractor with the tooth located in the tooth chamber therein.

2. The method of claim 1, wherein the tooth chamber has an opening that is circular shape.

3. The method of claim 1, wherein said tooth chamber has an opening that has two protrusions extending down from the edge of the tooth chamber opening, a first protrusion to be placed on an outside of a tooth, and a second protrusion to be located opposite the first protrusion and to fit over an opposite side of a tooth.

4. The method of claim 3, wherein the first and second protrusion are placed over the tooth before striking the tooth extractor.
